(19) United States
(12) Patent Application Publication
(10) Pub. No.: US 2008/0122312 A1
(43) Pub. Date: May 29, 2008

(54) Pancake style kinetic energy electrical generator

(76) Inventor: Richard M. Dickson, Milwaukie, OR (US)

Correspondence Address: Mr. Richard M. Dickson, PO Box 220305, Milwaukie, OR, 97269, US

(21) Appl. No.: 11/986,341

(22) Filed: Nov. 20, 2007

Related U.S. Application Data
(60) Provisional application No. 60/860,979, filed on Nov. 24, 2006.

(51) Int. Cl. H02K 1/28

(52) U.S. Cl. 310/268

(57) ABSTRACT

An apparatus to convert motion in the external environment into direct current electricity, comprising a round, pancake style, compressed canister, consisting of two round opposing faceplates held together by a central screw and post, passing through a rotor consisting of a central, hollow, core round disc-shaped magnet or magnets, sandwiched in the center of aforesaid opposing faceplates, around which a round, disc-shaped magnet or magnets orbit(s) radially and freely, held to the aforesaid central rotor magnet or magnets by magnetic polarity attraction only, and aforesaid central freely rotating magnet or magnets convert(s) the ambient kinetic energy vibrations to electricity via radial rotation about the aforesaid fixed central, round, disc-shaped central rotor core magnet or magnets, while just touching the round electrically conductive, toroidally shaped stator coil, sandwiched between the outside perimeters of the aforementioned two opposing canister faceplates; and the variable direct current electricity thus generated is then passed via commutator ends on the aforesaid toroidally shaped conductive stator coil to either recharge external batteries or provide direct electrical power to external electrical/electronics devices.

### CROSS-REFERENCE TO RELATED APPLICATIONS

This application claims benefit of U.S. Provisional Application Ser. No. 60/860,979, entitled, “Pancake style kinetic energy electrical generator”, and filed Nov. 24, 2006.

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISK APPENDIX

None

### BACKGROUND OF THE INVENTION

1. Field of the Invention

The present invention relates to a system and method of generating electrical energy from motion, and more particularly to an apparatus and method for generating direct current (DC) electricity from kinetic energy harvested from vibrating motion in the environment, which impacts the invention, and then processing the electrical energy thus generated to power electrical devices connected thereto, to store the electrical energy for later use, or to recharge one or more rechargeable batteries.

2. Description of the Related Art

Electrical generators are widely known in the prior art, and knowledge of basic principles of mechanical electrical generators is within the public domain. However, electrical generators in the prior art, which convert kinetic energy into electrical power, are more complicated than the proposed invention, and do not capture or convert kinetic energy into electricity as efficiently as the proposed invention.

Additionally, no prior art utilizes magnetic polarity attraction a key component of the electrical generator rotor design. Nor does any prior art utilize a split rotor, consisting of two disc shaped magnets interacting with each other. Also, no prior art uses a bifurcated stator positioned on either side of the rotor and connected via a central stator core. Finally, no prior art allows for ease in increasing the electrical generator's power by utilizing magnetic attraction to stack rotating disc shaped magnets in the rotor, thus increasing the power of the rotor, and hence the electrical output of the proposed invention. As such the proposed invention breaks new technical ground.

U.S. Pat. No. 7,105,939 to Bednyak proposes a kinetically powered electrical generator, deriving its electrical energy from motion of the device using an internal oscillator. However, the device is more complex than the proposed invention with more moving parts, and concomitantly more opportunity for failure over the long-term. Additionally, U.S. Pat. No. 7,105,939 does not utilize a split, rotating magnetic rotor using disc-shaped magnets as does the proposed invention.

U.S. Pat. No. 7,266,396 to Terzian et al. comes closest to the proposed invention by using a closed loop raceway, with an electrically conductive wire wrapped around the exterior of the raceway, and then a magnetic ball that moves freely inside the raceway in response to movement of the device. The magnetic ball serves as the rotor. However, this device does not use an orbiting split magnetic rotor, as does the proposed invention. The proposed invention also allows for three hundred and sixty degree rotation of the magnetic rotor inside the conductive wire coil, while U.S. Pat. No. 7,266,396 uses a less efficient “figure eight” design.

Other References Cited: U.S. Pat. Nos. 3,204,110, 3,231,749, 4,260,901, 4,423,334, 4,821,218, 5,271,328, 5,941,692, 6,020,653, 6,172,426, 6,316,906, 6,791,205, 5,460,099, 5,552,657, 5,708,206, 6,791,205, 68,255,574, 6,935,808; and Foreign Patent Documents 618380 (October 1994, EP), 56052581 (May 1981, JP), 06280934 (October 1994, JP), 09053681 (February 1997, JP), 10026553 (January 1998, JP), 10257711 (September 1998, JP), 20002142498 (May 2002, JP), and 20032274456 (August 2003, JP).

### BRIEF SUMMARY OF THE INVENTION

The object of the present invention is an improved kinetic electrical energy generator, which uses fewer moving parts than prior art designs in a compact, simple, robust and compressed pancake design for use in harvesting kinetic energy from vibrating motion in the environment, converting it to direct current, and then using the electrical energy thus generated to either recharge batteries or directly power electrical/electronics devices.

The proposed invention provides an internal kinetic energy electrical generator, coupled to other components of low voltage electrical/electronics devices to avoid the use of external electrical power in order to provide renewably generated low voltage to electrical/electronics devices. The proposed invention uses motion generated external to the electrical/electronics device it is coupled to in order to generate electricity to power aforesaid devices.

The preferred embodiment of the present invention operates as follows: the rotor, consisting of one or more round, disc-shaped, permanent magnets (magnetic material is not specified, but ceramics is one option) with center hole(s) is/are secured in the center of a round, pancake (i.e., compressed) style canister, consisting of two opposing round faceplates. One or more round, disc-shaped permanent magnets with opposite polarity to the aforesaid central fixed rotor magnets are held to the central disc-shaped, round permanent rotor magnet(s) via magnetic polarity attraction only; and thus are free to orbit the aforesaid centrally mounted disc-shaped rotor magnet, inside the aforesaid pancake canister, when impacted by ambient environmental motion external to the proposed invention. An outer stator coil of electrically conductive wire is wound around a toroidally shaped ring of conductive material, which is positioned around the outer edge of the aforesaid orbiting rotor magnet(s), so that as the aforesaid rotor freely orbiting magnet (s) rotate(s) about the aforesaid fixed central magnet at the rotor core, and just touching the aforesaid outer toroidally shaped stator coil, variable direct current electricity is generated inside the aforesaid outer stator coil and is then transferred via commutators to either external batteries or directly to electrical/electronics devices.

Thus, the operating principle of the proposed invention is greatly simplified over prior art mechanical and kinetic energy electrical generators. As the proposed invention's pancake-style (i.e., compressed) canister is vibrated by motion from the surrounding environment, these vibrations cause the canister to move back and forth on its axis. As it does so, the aforesaid free-rotating rotor magnet (s) begin(s) to move radially around the axis of the aforesaid fixed central stator magnet(s). Depending upon the force vectors impacting the aforesaid pancake-style canister, the freely rotating rotor magnet(s) can either rotate completely around the aforesaid central fixed rotor core magnet or swing back and forth erratically, pendulum-style. In whatever direction the aforesaid freely orbiting rotor magnet(s) move, direct current electricity is generated, as it moves over the outer round toroidally shaped conductive coil. Thus, external environment vibrating motion, no matter how erratic, is converted to electricity by the proposed invention when said external vibrating motion impacts the proposed invention. This electricity is then transmitted via commutator connections in the aforesaid stator to either external rechargeable batteries or directly to power electrical/electronic devices.

### BRIEF DESCRIPTION OF THE DRAWINGS

FIG. 1 is a top-down view of the preferred embodiment of the proposed invention. [Note: reference numbers are the same in all drawings.]

FIG. 2 is a cross-sectional side schematic view of the preferred embodiment of the proposed invention.

FIG. 3 is a top-down view of an alternate embodiment of the proposed invention in which the conductive copper coil is not on the outside perimeter of the proposed invention, but actually embedded into both sides of the opposing faceplates of the round canister portion of the proposed invention and bisecting the orbit of the free-moving round, disc-shaped magnet portion of the rotor.

### DETAILED DESCRIPTION OF PREFERRED EMBODIMENTS

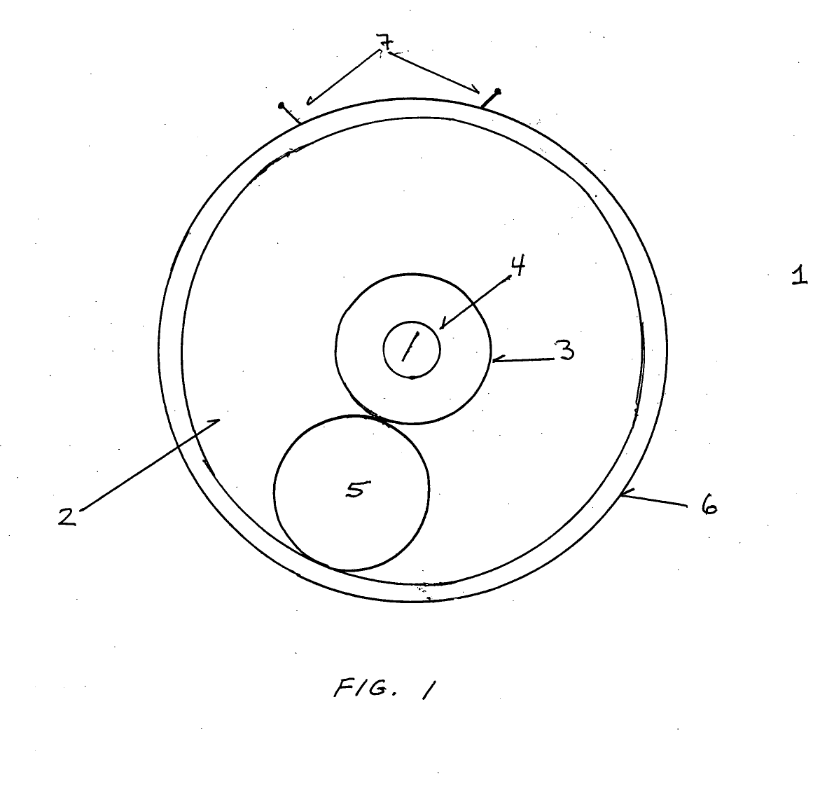

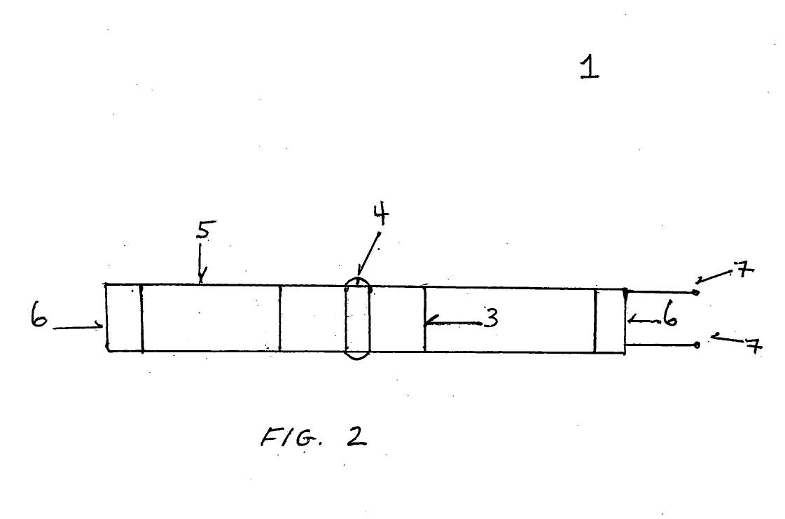

Now referring to FIGS. 1 and 2, both make adequate disclosure of the proposed pancake style kinetic energy electrical generator invention to someone with ordinary skill in the art. It should be noted that FIGS. 1 and 2 are not true to scale, but that by varying size and distances of component parts, improved performance will be achieved for the preferred embodiment of the proposed invention.

Referring to FIG. 1, the external environment is represented at 1. The round, pancake style canister housing the proposed invention is at 2. The fixed round, disc-shaped central rotor core magnet(s) is/are shown at 3. A hole in the fixed round, disc-shaped central rotor core magnet (s) is filled by a screw top shown at 4 passing through the top round faceplate of aforesaid canister housing, then through the fixed central rotor magnet(s) and then out the other side through the opposing bottom round canister faceplate where said screw top is then mated to a screw bottom piece to hole the aforesaid top and bottom canister faceplates in position with the aforesaid central rotor core magnet(s) sandwiched in between the aforesaid top and bottom canister faceplates. The freely orbiting round, disc-shaped rotor magnet(s) is/are shown at 5, and held to the aforesaid fixed central rotor core magnet(s) shown at 3 by magnetic polarity attraction only. The outer, toroidally shaped stator electrically conductive coil is shown at 6 and is sandwiched between the two opposing canister faceplates shown at 2, and just touching the outer orbit of the freely rotating rotor magnet(s) shown at 5. The commutator ends of the stator coil (shown at 6) are at 7.

Referring to FIG. 2, the external environment is shown at 1. The two opposing canister faceplates are shown at 2. The fixed, round, disc-shaped central core magnet(s) is/are shown at 3. A hole in aforesaid fixed, round, disc-shaped central rotor core magnet(s), passing through aforesaid top and bottom opposing canister faceplates is shown at 4. The freely orbiting round, disc-shaped rotor magnet(s) is/are shown at 5, and held to aforesaid fixed central rotor core magnet(s) shown at 3 by magnetic polarity attraction only. The toroidally shaped stator electrically conductive coil is shown at 6. The commutator ends of the stator coil (shown at 6) are at 7.

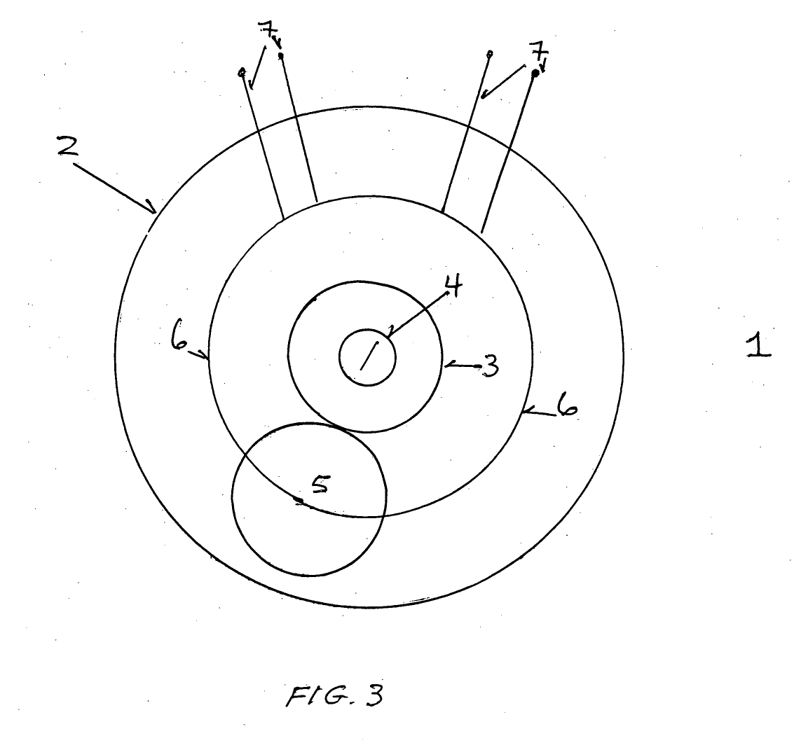

Referring to FIG. 3, the external environment is shown at 1. The two opposing canister faceplates are shown at 2. The fixed, round, disc-shaped central core magnet(s) is/are shown at 3. A hole in aforesaid fixed, round, disc-shaped central rotor core magnet(s), passing through aforesaid top and bottom opposing canister faceplates is shown at 4. The freely orbiting round, disc-shaped rotor magnet(s) is/are shown at 5, and held to aforesaid fixed central rotor core magnet(s) shown at 3 by magnetic polarity attraction only. The electrically conductive stator coil is shown at 6. The commutator ends of the stator coil are at 7.

Now referring to FIGS. 1 and 2, the preferred embodiment of the proposed invention operates as follows: vibrating motion from the environment shown at 1, impacts the generator canister at 2, causing it to vibrate about its axis. This vibrating motion causes the freely orbiting round, disc-shaped rotor magnet(s), shown at 5, to move radially about the axis of the fixed, round, disc-shaped central rotor core magnet(s) at 3. The aforesaid freely orbiting rotor magnet(s) shown at 5 orbit radially inside the two opposing canister faceplates shown at 2. The movement(s) of the orbiting rotor magnet(s) at 5, when impacted by external environmental motion, causes it/them to either move erratically in a radial fashion, pendulum style (i.e., back and forth), or completely around the central stator core magnet(s) shown at 3. In whatever direction aforesaid freely orbiting rotor magnet(s) shown at 5 move, they generate electricity by rolling lightly over the outer toroidally shaped electrically conductive stator coil shown at 6, which is sandwiched inside the opposing canister faceplates shown at 2, but on the very outside perimeter of aforesaid faceplates at 2. When direct current electricity is thus generated it is transmitted via the commutator ends of the stator coil, shown at 7, to either external rechargeable batteries or directly to external electrical/electronics devices.

Now referring to FIG. 3, the alternative embodiment of the proposed invention operates as follows: vibrating motion from the environment shown at 1, impacts the generator canister at 2, causing it to vibrate about its axis. This vibrating motion is enough kinetic energy to cause the freely orbiting round, disc-shaped rotor magnet(s) shown at 5 to move radially about the axis of the fixed, round, disc-shaped central rotor core magnet(s) at 3. The aforesaid freely orbiting rotor magnet(s) shown at 5 orbit radially inside the two opposing canister faceplates shown at 2. The movement(s) of the orbiting rotor magnet(s) at 5, when impacted by external environmental motion, causes it/them to either move erratically in a radial fashion, pendulum style (i.e., back and forth), or completely around the central stator core magnet(s) shown at 3. In whatever direction aforesaid freely orbiting rotor magnet(s) shown at 5 move, it/they generate electricity by passing close to the electrically conductive stator coil shown at 6, which is embedded inside both opposing canister faceplates shown at 2, bisecting the orbit of the freely orbiting rotor magnet(s) at 5. Both aforesaid embedded faceplate conductive coils are connected via conductive material passing through the center hole of the fixed rotor magnet, thus linking the two faceplate conductive coils. When direct current electricity is thus generated it is transmitted via the commutator ends of the stator coils, shown at 7, to either external rechargeable batteries or directly to external electrical/electronics devices.

What is claimed is:

1. An apparatus which harvests external physical motion from the environment and converts it to direct current electricity, and which apparatus comprises a round, pancake style, compressed canister, consisting of two round opposing faceplates held together by a central screw and post, passing through a rotor consisting of a central, hollow, core round disc-shaped magnet or magnets (if stacked together), sandwiched in the center of aforesaid opposing faceplates, around which a round, disc-shaped magnet or magnets (if stacked together) orbits radially and freely, held to the aforesaid central rotor magnet or magnets by magnetic polarity attraction only, and aforesaid central freely rotating magnet or magnets convert(s) the ambient kinetic energy vibrations to electricity via radial rotation of the aforesaid freely moving round, disc-shaped magnet or magnets about the aforesaid fixed central, round, disc-shaped central rotor core magnet or magnets, while just touching the round electrically conductive, toroidally shaped stator coil, sandwiched between the outside perimeters of the aforementioned two opposing canister faceplates; and said variable direct current electricity thus generated is then passed via commutator ends on the aforesaid toroidally shaped conductive stator coil to either recharge external batteries or provide direct electrical power to external electrical/electronics devices.

2. An apparatus according to claim 1 in which the conductive stator coil is not on the outer perimeter of aforesaid canister housing the proposed invention, but is instead embedded in each opposing faceplate to bisect the orbit of the freely rotating disc-shaped magnet or magnet(s) portion of aforesaid rotor; and is linked via conductive material passing through the center hole of the aforesaid hollow central rotor magnet, so that the coils embedded in both faceplates are electrically connected.

3. An apparatus according to claim 1 in which the aforesaid canister can be shaped other than round.

4. An apparatus according to claim 1 in which the conductive stator coil can be other than toroidally shaped.

5. An apparatus according to claim 1 in which the conductive stator coil can be composed of spiral flat conductive material strips, which would allow for smoother rotation of the aforesaid freely moving round, disc-shaped rotor magnet(s).

6. An apparatus according to claim 1 in which the aforesaid freely moving rotor magnet(s) could be ball-shaped, instead of disc-shaped.
